(19) United States
(12) Patent Application Publication
(10) Pub. No.: US 2026/0023987 A1
(43) Pub. Date: Jan. 22, 2026

(54) DYNAMIC ADAPTATION OF RESOURCES TO EDGE NODES

(71) Applicant: International Business Machines Corporation, Armonk, NY (US)

(72) Inventors: Maja Curic, Munich (DE); Sagar Tayal, Ambala City (IN); David Jason Hunt, Kirkwood, MO (US); Alecio Pedro Delazari Binotto, Munich (DE)

(21) Appl. No.: 18/780,255

(22) Filed: Jul. 22, 2024

(51) Int. Cl. G06N 5/022; G06F 11/34

(52) U.S. Cl. CPC G06N 5/022; G06F 11/3409

(57) ABSTRACT

A computer-implemented method, according to one approach, includes: receiving information from an edge node, where the information outlines specific retrieval-augmented generation (RAG) data applied at the edge node, as well as a condition of the edge node, in real-time. A knowledge database which maps embeddings of RAG data to various edge node conditions is further updated with the received information. Moreover, one or more trained artificial intelligence based models are used to dynamically evaluate the received information and the knowledge database. The artificial intelligence based models are also used to output a relevant subset of RAG data. The relevant subset of RAG data is further sent to the edge node.

### BACKGROUND

The present invention relates to edge nodes, and more specifically, this invention relates to sending resources to edge nodes.

Data production has amplified the overhead associated with data management and processing. While AI has been developed in an attempt to combat this rise in processing overhead, advancements in AI have caused the complexity of machine learning models to increase as well. Increasingly complex machine learning models translate to more intense workloads and increased strain associated with applying the models to received data. The operation of conventional implementations has thereby been negatively impacted.

Cloud computing has been implemented in an effort to improve the ability to perform computationally intense operations and process an increasing amount of data. For instance, cloud locations can be tailored to provide a dynamic level of computational throughput which adjusts to meet a client's needs. While this is effective in preventing processing bottlenecks from developing, it involves sending all data being analyzed to a centralized location, such as a data center or public cloud location. Sending data to a centralized location exposes it to unwanted attacks and unintentional mishandling, thereby significantly increasing the risk of data loss.

In an attempt to combat this reliance on a network to perform all processing at a central location, edge computing has been implemented to extend computing to the endpoints in a system. For instance, applications and other types of compute operations are moved to the edge locations where the data is generated in the interest of data privacy and security. However, this has also introduced inefficiencies in conventional products that have gone unsolved.

### SUMMARY

A computer-implemented method (CIM), according to one approach, includes: receiving information from an edge node, where the information outlines specific retrieval-augmented generation (RAG) data applied at the edge node, as well as a condition of the edge node, in real-time. A knowledge database which maps embeddings of RAG data to various edge node conditions is further updated with the received information. Moreover, one or more trained artificial intelligence (AI) based models are used to dynamically evaluate the received information and the knowledge database. The AI based models are also used to output a relevant subset of RAG data. The relevant subset of RAG data is further sent to the edge node.

A computer program product (CPP), according to another approach, includes: a set of one or more computer-readable storage media. The CPP also includes program instructions that are collectively stored in the set of one or more storage media, and are for causing a processor set to perform the following computer operations:

A computer system (CS), according to yet another approach, includes: a processor set, and a set of one or more computer-readable storage media. The CS also includes program instructions that are collectively stored in the set of one or more storage media, and are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational diagram of dynamically adapting RAG data sent to an edge node, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 3C is a flowchart for predicting future edge node conditions and/or performance metrics, in accordance with one approach.

FIG. 4 is a representational diagram of a distributed system, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamically adapting the amount and/or type of supplies that are provided to edge nodes. For instance, approaches herein involve dynamically determining the amount and/or type of RAG data to send to edge nodes over time, based at least in part on the real-time performance at the edge nodes themselves. This results in the performance improving at each edge node, as well as the system as a whole operating more efficiently, e.g., as will be described in further detail below.

The following description may disclose approaches of improving the efficiency by which multitask model tuning (or “multitask fine-tuning”) may be performed. It should be appreciated that various approaches herein can be implemented with a wide range of multitask model tuning types, including for example multitask prompt tuning, multitask prefix tuning, etc., or any other type of multitask model tuning that would be apparent to one skilled in the art after reading the present description. To provide a context, and solely to assist the reader, various approaches may be described with reference to a type of multitask model tuning. For instance, many approaches are described in the context of multitask prompt tuning (MPT). This has been done by way of example only, and should not be deemed limiting.

In one general approach, a CIM includes: receiving information from an edge node, where the information outlines specific RAG data applied at the edge node, as well as a condition of the edge node, in real-time. A knowledge database which maps embeddings of RAG data to various edge node conditions is further updated with the received information. Moreover, one or more trained AI based models are used to dynamically evaluate the received information and the knowledge database. The AI based models are also used to output a relevant subset of RAG data. The relevant subset of RAG data is further sent to the edge node.

It follows that approaches herein are desirably able to dynamically adapt the amount and/or type of supplies that are provided to edge nodes. For instance, approaches herein involve dynamically determining the amount and/or type of RAG data to send to edge nodes over time, based at least in part on the real-time performance at the edge nodes themselves. This results in only relevant portions of RAG data to be sent to each respective edge node, causing performance improvements at each edge node, as well as causing the system as a whole to operate more efficiently.

In some implementations, the CIM further includes receiving performance metrics from the edge node. Edge node condition information that corresponds to the edge node may also be received therefrom. In response to receiving the performance metrics and/or the edge node condition information from the edge node, the one or more trained AI based models dynamically evaluate the performance metrics, the edge node condition information, the received information, and the knowledge database. The trained AI based models also output the relevant subset of RAG data.

By evaluating performance metrics and/or condition information that corresponds to a given edge node, in addition to information that outlines specific RAG data applied at the edge node, approaches herein are able to dynamically adjust the resources being sent to the edge node in finer detail. In other words, this additional information received from the edge node is used to develop a more detailed understanding of what resources (e.g., RAG data) is relevant (e.g., useful) to the edge node. This is further used to adjust resources sent to the edge node in real time.

In some implementations, the knowledge database is formed by: dividing base data into a number of segments, and converting the segments into the embeddings. The embeddings are further combined with respective information to form vector storage pools for the respective embeddings. Approaches herein are thereby able to easily search the vector storage pools and use the information therein to train AI based models. Moreover, as the data in the vector storage pools changes over time, the AI based models may be retrained to incorporate the new information and provide a relevant grouping of resources (e.g., RAG data) to the edge node over time.

In some implementations, the operations are performed by a centralized edge orchestrator. Accordingly, relevant subsets of RAG data are sent to the edge node along a RAG pipeline that extends between the edge node and the centralized edge orchestrator. The centralized edge orchestrator may also be connected to other edge nodes along the same or different RAG pipelines, and may selectively send resources to the other edge nodes (e.g., in parallel and simultaneously) in a similar manner.

In some implementations, the CIM further includes causing one or more generative AI models to predict future edge node conditions. The one or more trained AI based models are also used to dynamically evaluate the future edge node conditions and the knowledge database. The trained AI based models further output a subset of RAG data with anticipated relevancy.

Determining what resources are anticipated as being relevant at some point in the future allows for approaches herein to deliver resources to remote locations (e.g., edge nodes) more accurately than previously achievable. AI model(s) may be trained in other approaches by applying a predetermined training data set to learn how to predict future edge node conditions and/or performance metrics. For example, AI models may be trained to evaluate the future edge node conditions and the knowledge database and output a subset of RAG data with anticipated relevancy. Accordingly, the subset of available RAG data predicted as being relevant to the future conditions and/or performance metrics is actually output by the trained AI based models.

In some implementations, the subset of RAG data with anticipated relevancy output by the trained AI based models impacts RAG data currently being sent to an edge node. The CIM further includes replacing at least a portion of the relevant subset of RAG data with at least a portion of the subset of RAG data. Furthermore, a remainder of the relevant subset of RAG data, and the subset of RAG data, are sent to the edge node. The trained AI based models are thereby able to make complex evaluations of information on the fly and generate detailed outcomes. These are further used to dynamically adjust resources being sent to the edge node on the fly, and adapt to situations as they arise at the edge node(s).

In another general approach, a CPP includes: a set of one or more computer-readable storage media. The CPP also includes program instructions that are collectively stored in the set of one or more storage media, and are for causing a processor set to perform any combination(s) of the foregoing methodologies.

In yet another general approach, a CS includes: a processor set, and a set of one or more computer-readable storage media. The CS also includes program instructions that are collectively stored in the set of one or more storage media, and are for causing the processor set to perform any combination(s) of the foregoing methodologies.

In some implementations, a centralized edge orchestrator is connected to one or more remote edge nodes along one or more resources pipelines. In response to receiving a request from one of the edge nodes (e.g., from an application running thereat), the centralized edge orchestrator sends resources (e.g., RAG data) to the edge node. Information describing how the resources (e.g., RAG data) sent to the edge node is actually used at the edge node, is returned to the centralized edge orchestrator. Accordingly, the centralized edge orchestrator is able to evaluate the received information to determine how the sent resources are being utilized. The centralized edge orchestrator is able to adjust resources being sent to the edge node on the fly, and dynamically adapt to situations as they arise at the edge node(s). Moreover, the centralized edge orchestrator is able to manage any desired number of edge nodes in this manner, thereby significantly improving performance and utilization of available system resources.

Various aspects of the present disclosure are described by narrative text, flowcharts, block diagrams of computer systems and/or block diagrams of the machine logic included in CPP approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved relevancy determination code at block 150 for dynamically adapting the amount and/or type of supplies that are provided to edge nodes. For instance, approaches herein involve dynamically determining the amount and/or type of RAG data to send to edge nodes over time, based at least in part on the real-time performance at the edge nodes themselves. This results in only relevant portions of RAG data to be sent to each respective edge node, causing performance improvements at each edge node, as well as causing the system as a whole to operate more efficiently, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

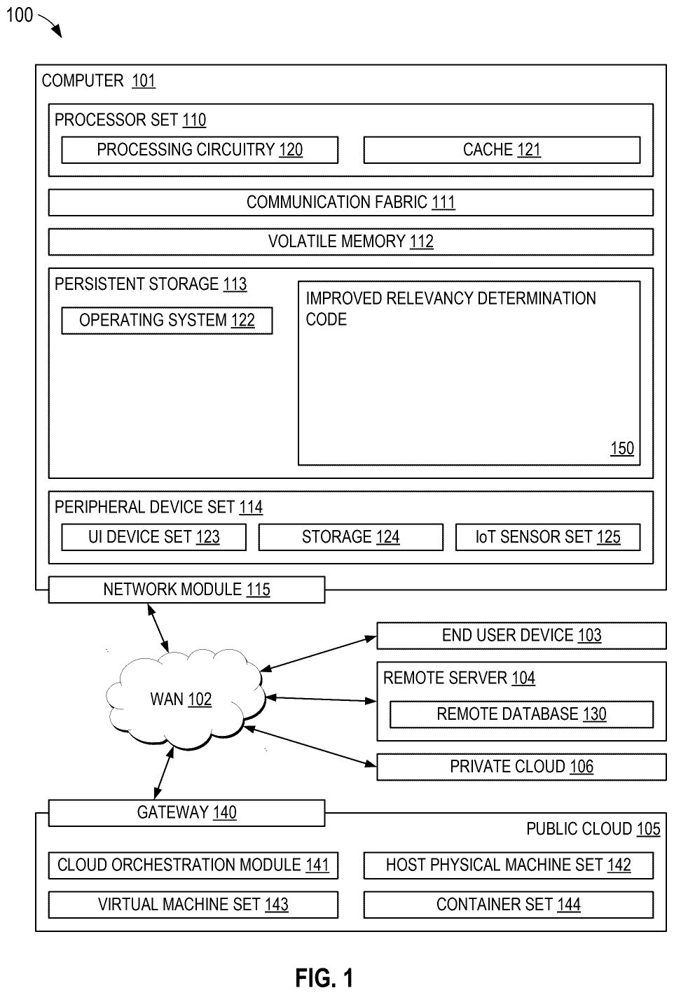

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is SaaS where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, increased data production has amplified the overhead associated with data management and processing. While AI has been developed in an attempt to combat this rise in processing overhead, advancements in AI have caused the complexity of machine learning models to increase as well. Increasingly complex machine learning models translate to more intense workloads and increased strain associated with applying the models to received data. The operation of conventional implementations has thereby been negatively impacted.

Cloud computing has been implemented in an effort to improve the ability to perform computationally intense operations and process an increasing amount of data. For instance, cloud locations can be tailored to provide a dynamic level of computational throughput which adjusts to meet a client's needs. While this is effective in preventing processing bottlenecks from developing, it involves sending all data being analyzed to a centralized location, such as a data center or public cloud location. Sending data to a centralized location exposes it to unwanted attacks and unintentional mishandling, thereby significantly increasing the risk of data loss.

In an attempt to combat this reliance on a network to perform all processing at a central location, edge computing has been implemented to extend computing to the endpoints in a system. For instance, applications and other types of compute operations are moved to the edge locations where the data is generated in the interest of data privacy and security. For example, data may not be allowed to leave the borders of a particular country to enhance the security and privacy of the data. In another example, a company may prefer to store generated data at an edge location (e.g., “on prem”) such that it is not shared over a network.

While these types of data management schemes may increase data integrity, they significantly increase the compute overhead associated with doing so. For instance, edge locations often experience different settings, local constraints, demands, etc., which change rapidly over time. Conventional products have thereby been forced to supply edge locations with enough supplies to operate across a wide range of conditions. According to an example, which is in no way intended to be limiting, conventional products are forced to oversupply RAG data to edge locations in an attempt to avoid edge locations training and deploying an inaccurate large language model (LLM). However, this has undesirably caused network traffic and edge node latency to increase significantly. This issue has resulted in heavy data storage and slow data retrieval times being experienced in conventional implementations.

In sharp contrast to the foregoing shortcomings experienced by conventional systems, approaches herein are desirably able to dynamically adapt the amount and/or type of supplies that are provided to edge nodes. This on-the-fly adaptation is based at least in part on the real-time performance experienced at the edge nodes themselves and/or other locations in a distributed system. This results in the performance improving at each edge node, as well as the system as a whole operating more efficiently, e.g., as will be described in further detail below.

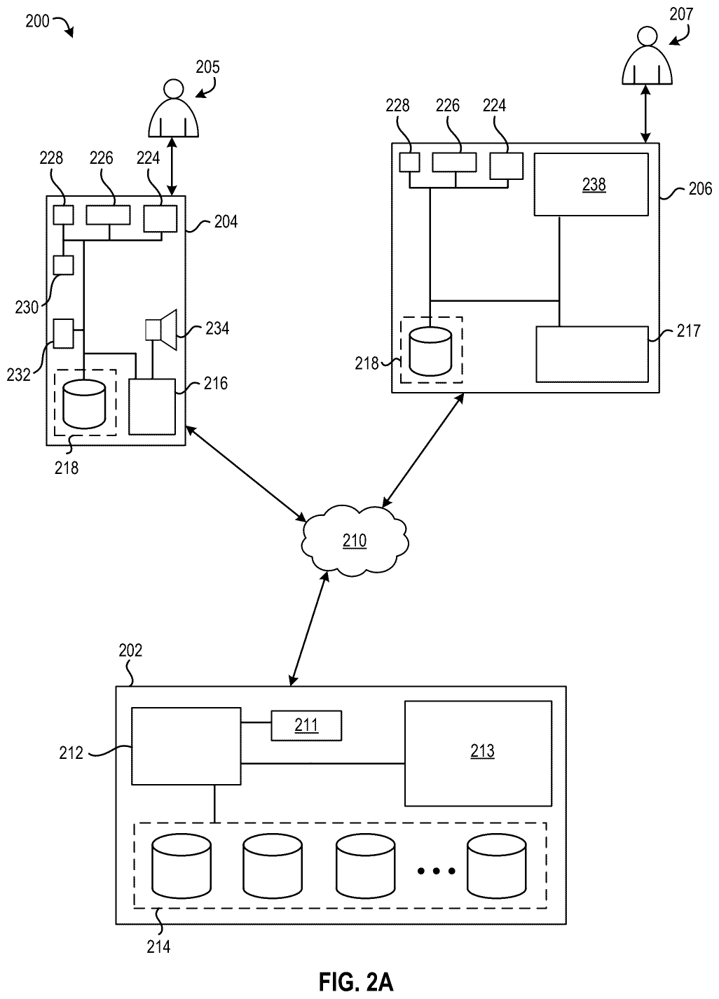

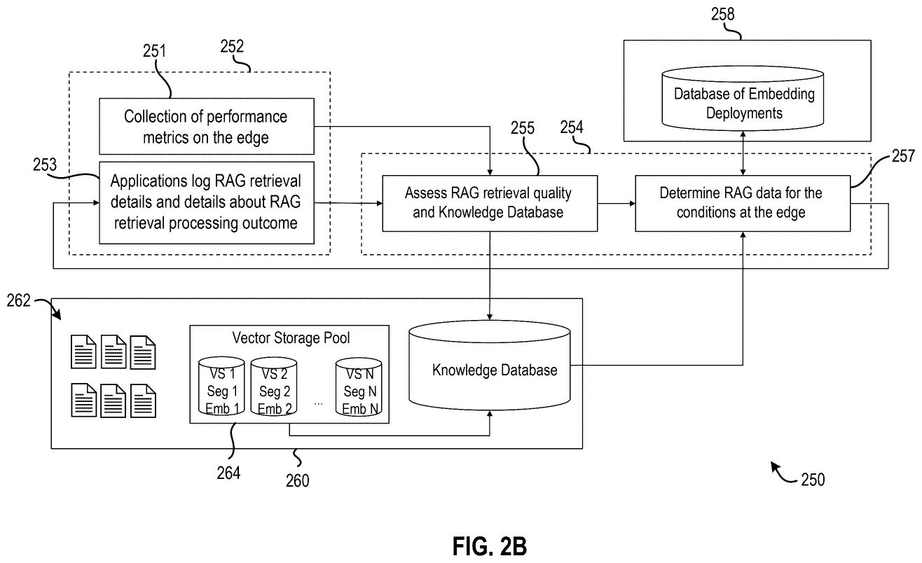

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” and “information” herein are in no way intended to be limiting either, and may include any desired type of details, e.g., depending on the type of operating system implemented on the user device 204, edge node 206, and/or central server 202.

In some approaches, portions of a dataset of textual entries (e.g., strings of alphanumeric characters) that have been generated at, received at, stored at, identified at, etc. the central server 202 may be sent to the edge node 206. According to an example, the central server 202 may manage a knowledge database that maps a number of embeddings of RAG data to corresponding edge node conditions. In other words, the knowledge database may correlate specific RAG data embeddings to edge node conditions in which the specific RAG data was applied (e.g., received and actually utilized) at the respective edge nodes. Entries in the knowledge database that match conditions experienced at an edge node may thereby be used to train one or more AI based models that are thereby able to identify specific RAG data that is relevant to a given situation, e.g., as will be described in further detail below.

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 and/or processor 212 are able to train one or more AI based models. For instance, AI model(s) may be trained in some approaches by applying a predetermined training data set to learn how to evaluate information associated with an edge node. For example, AI models may be trained to evaluate performance metrics, edge node condition information, information outlining specific resources (e.g., RAG data) applied at edge nodes, knowledge databases, etc., and output resources that are relevant to the evaluated information. AI model(s) may be trained in other approaches by applying a predetermined training data set to learn how to identify resources that are relevant to the evaluated information. For example, AI models may be trained to identify RAG data that is relevant to the evaluate performance metrics, edge node condition information, etc., and output it. AI model(s) may be trained in other approaches by applying a predetermined training data set to learn how to predict future edge node conditions and/or performance metrics. For example, AI models may be trained to evaluate the future edge node conditions and the knowledge database and output a subset of RAG data with anticipated relevancy.

In some approaches, this may be achieved by implementing prompt tuning, more specifically MPT. With respect to the present description, “prompt tuning” refers to the process of adapting a base pretrained model to each desired task via conditioning on learned prompt vectors. For instance, prompt tuning may be used to efficiently adapt LLMs to multiple downstream tasks. It should also be noted that “MPT” refers to a process, which initially includes learning a single transferable prompt by distilling knowledge from multiple task-specific source prompts. Furthermore, multiplicative low rank updates to this shared prompt are learned to efficiently adapt it to each downstream target task, e.g., as would be appreciated by one skilled in the art after reading the present description. As a result, approaches herein are able to exploit the rich cross-task knowledge with prompt vectors in a multitask learning setting.

According to some approaches, the AI module 213 and/or data storage array 214 includes a vector storage pool that includes a number of datasets that have each been applied to a number of encoding models. Each encoding model may correspond to a different LLM that is supported by the system. In other words, each encoding model may apply a different language space that interprets a given dataset in a way that is unique to the respective LLM. The LLMs that are supported by the system may include, but are in no way limited to, the T5 transformer model, the Bidirectional Encoder Representations from Transformers (BERT) language model, the ELECTRA language model, etc., or any other LLMs (e.g., language spaces) that would be apparent to one skilled in the art after reading the present description.

Each entry in the vector database may be compared against vector information received from other locations. For example, a mean vector received from the edge node 206 may be compared against the entries in the vector database and identify the “N” entries that are a closest match to the received mean vector. In some approaches, entries in the vector database may be organized such that the distance between entries is inversely proportional to how similar the entries are. A received mean vector may thereby be plotted in the vector database and the “N” closest entries may be selected as the datasets that are a closest match to the dataset that produced the mean vector, e.g., as would be appreciated by one skilled in the art after reading the present description.

With continued reference to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data (e.g., non-sensitive data) may be received from user 205 for storage and/or evaluation using AI module 213 at central server 202. The data may be received as a result of the user 205 using one or more applications, software programs, temporary communication connections, etc. running on the user device 204. For example, the user 205 may upload data for storage at the data storage array 214 and evaluation using processor 212 and/or AI module 213 of central server 202. As a result, the data is evaluated and processed.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include any desired number and/or type of AI-based models. It follows that AI module 238 may implement similar, the same, or different characteristics as AI module 213 in central server 202. In some approaches, AI module 238, controller 217, and/or edge node 206 as a whole may be configured to operate in ultra-low latency situations (e.g., less than about 1 millisecond). It follows that moving more compute intensive applications to edge locations involves integration.

For example, the process of sending RAG data to edge locations for implementation in LLMs “on the edge” preferably involves tailoring the content that is sent along RAG pipelines. In other words, only the content that is relevant for use cases is hosted at the edge locations, thereby ensuring that the retrieval mechanism does not impair ultra-low latency services. LLMs are also tuned to perform as desired in given conditions. This is also referred to herein as edge nodes supporting “slim RAG” in order to reduce overhead and latency. This also desirably achieves faster searches and faster total LLM response, which is particularly important for operations being performed on the edge. As noted above, the dynamic nature of the network edges causes the importance of resources that are ingested in the RAG pipeline on the edge to have shifting importance. For instance, different edge nodes have different characteristics across the network. Edge nodes can have equipment from different vendors, different types of users, different locations, etc. Conditions at an edge node can also change throughout the day. For instance, different traffic patterns may be observed in the morning in comparison to the evening, different types of users attach on different days, etc. According to an example, VIP users may connect to an application in the afternoon, compared to manufacturing facilities that operate during evening hours. In another example, morning operations may experience more coverage issues, while afternoon operations may experience more quality issues for VIP subscribers. This difference may be used to determine that more documentation on how to do operations with VIP subscribers is desired in the afternoon. Again, approaches herein achieve efficient LLM operation at edge locations by implementing slim RAG pipelines that promote fast data retrieval. This has been previously unachievable.

Referring momentarily now to FIG. 2B, a representational diagram 250 of dynamically adapting the amount and/or type of RAG data sent to an edge node based at least in part on the real-time performance at the edge node itself, is illustrated in accordance with one approach which is in no way intended to be limiting. As an option, the present diagram 250 may be implemented in conjunction with features from any other approach listed herein, such as those described with reference to the other FIGS., such as FIG. 2A. However, such diagram 250 and others presented herein may be used in various applications and/or in permutations which may or may not be specifically described in the illustrative approaches listed herein. Further, the diagram 250 presented herein may be used in any desired environment. Thus FIG. 2B (and the other FIGS.) may be deemed to include any possible permutation.

The process of learning the correct amount of RAG data to send to an edge node shifts over time as demand changes. Accordingly, an edge node 252 collects performance metrics (see operation 251) and sends them to a centralized edge orchestrator 254. The edge node 252 also collects information outlining the RAG data actually used at the edge node 252. Accordingly, operation 253 includes logging (e.g., storing) RAG data retrieval details along with details outlining how (or if) the retrieved RAG data was actually used. As shown, the information collected in operation 253 is also sent to the centralized edge orchestrator 254.

There, the centralized edge orchestrator 254 evaluates the information that is received from edge node 252. For instance, operation 255 includes assessing the RAG data retrieval quality and the knowledge database. The centralized edge orchestrator 254 also uses the information that is received from edge node 252 to update the Knowledge Database. It should be noted that the Knowledge Database and any related logical components in callout 260 may actually be located in one or more processors that are present at the centralized edge orchestrator 254, e.g., as would be appreciated by one skilled in the art after reading the present description.

The Knowledge Database is formed by dividing base data 262 into a number of text segments (e.g., chunks). The text segments are further converted into segmentation embeddings. Each embedding thereby corresponds to a respective smaller chunk of the original base data. Each of the embeddings are further combined with respective information to form a vector storage pool 264. As shown, the vector storage pool 264 includes a number of entries. In preferred approaches, the number of entries “N” is the same or similar to the number of embeddings formed by converting the base data into a plurality of smaller chunks.

Returning to the centralized edge orchestrator 254, the evaluation performed in operation 255 is passed to one or more AI models that have been trained to dynamically adapt the amount and/or type of RAG data that is provided to edge nodes. Accordingly, this on-the-fly adaptation is based at least in part on the real-time performance experienced at the edge nodes themselves and/or other locations in a distributed system. This results in the performance improving at each edge node, as well as the system as a whole operating more efficiently.

Accordingly, operation 257 includes dynamically determine the amount and/or type of RAG data to send to edge node 252 based at least in part on the real-time performance at the edge node 252 itself and the information accumulated and organized in the Knowledge Database. It should be noted that operation 257 preferably references (e.g., incorporate) a database of embedding deployments 258. In some approaches, the database of embedding deployments 258 may incorporate (e.g., consider) all relevant artifacts for each connected edge node. The database of embedding deployments 258 may also incorporate governance schemes that orchestrate operation of the overarching system. These governance schemes may be predetermined by a user, set based on industry standards, related to the operating language of running applications, output by one or more AI based models in response to evaluating input information, etc.

A tailored stream of RAG data is thereby produced using the outcome of operation 257. The relevant RAG data is thereby sent to the edge node 252 for implementation. It follows that the operations shown in FIG. 2B may be repeated over time in an iterative fashion to maintain a relevant stream of resources (e.g., RAG data) being sent to the edge node 252. Again, this allows for network traffic and processing overhead to be significantly reduced. In turn, this desirably increases the applicability of edge nodes and distributed application (e.g., processing) of data.

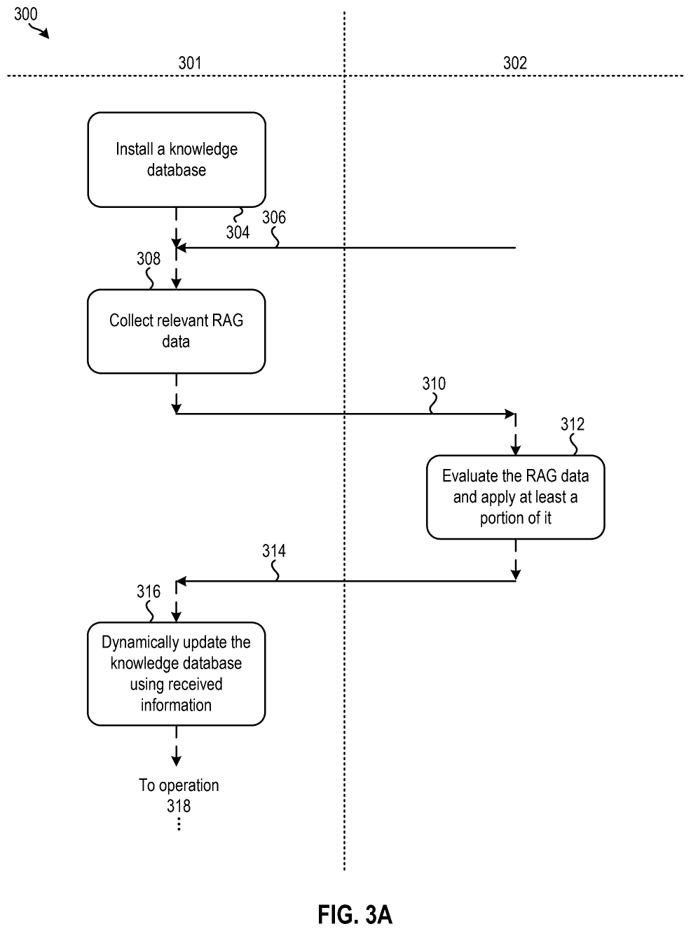

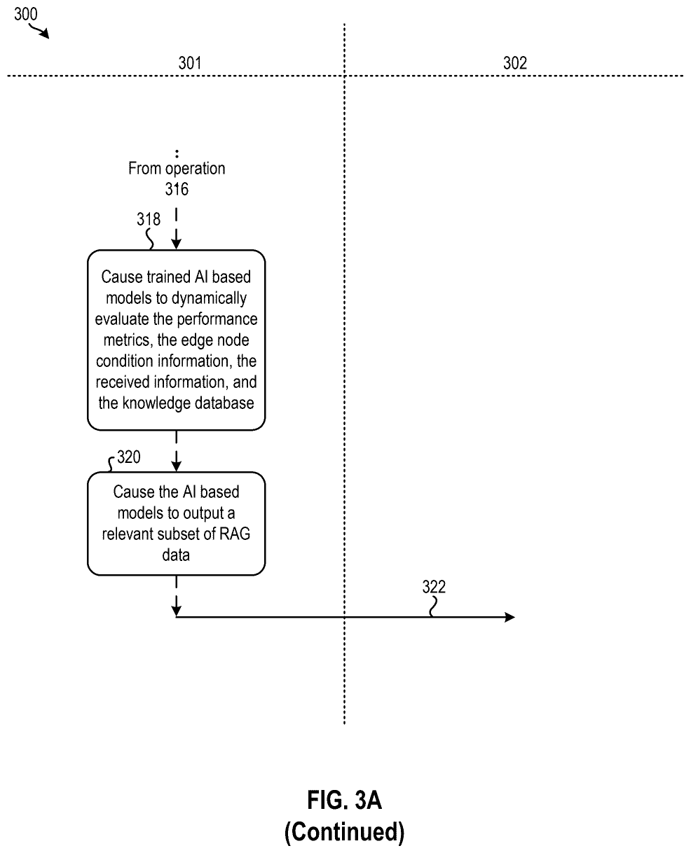

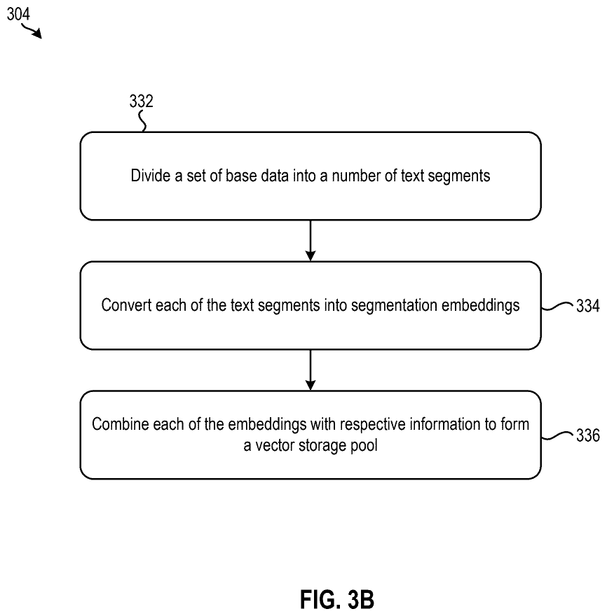

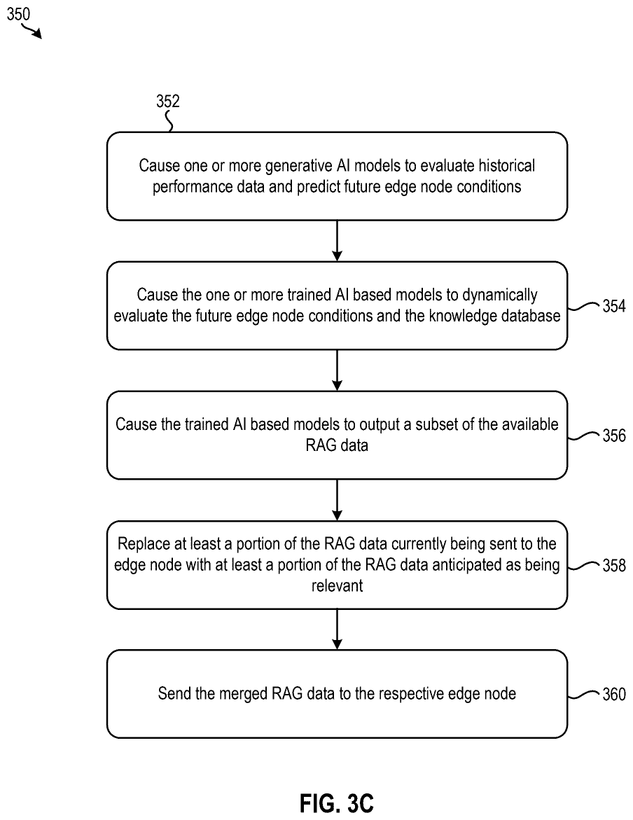

Looking now to FIG. 3A, a method 300 for dynamically adapting the amount and/or type of supplies that are provided to edge nodes. Specifically, method 300 involves dynamically determining the amount and/or type of RAG data that is sent to edge nodes over time, based at least in part on the real-time performance at the edge nodes themselves. This results in the performance improving at each edge node, as well as the system as a whole operating more efficiently, e.g., as will be described in further detail below.

Method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions. Each of the steps of the method 300 may be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes different nodes 301, 302, both of which represent one or more processors, controllers, computers, etc., positioned at a different location in a distributed system. For example, in some approaches one or more of the operations in method 300 may involve one or more physical components in an edge node of a distributed system. The edge node may further be one of a plurality that are coupled to a central server as part of a larger distributed system. Accordingly, node 301 may include one or more processors which are located at a central server of a distributed system (e.g., see processor 212 of FIG. 2A). Moreover, node 302 may include one or more processors which are located at a first edge node (e.g., see controller 217 in edge node 206 of FIG. 2A).

Accordingly, commands, code, data, metadata outlining code updates, etc., may be sent between the nodes 301 and 302, depending on the approach. It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches.

As shown in the flowchart, method 300 includes operation 304 which is performed at node 301. There, operation 304 includes installing a knowledge database. In other words, operation 304 includes initializing (e.g., establishing) a logical space that may be used to form and maintain a knowledge database. As used herein, a “knowledge database” may be used to store representations of various public datasets. For instance, the knowledge database may be formed by mapping embeddings of RAG data to various edge node conditions in which the RAG data was used.

Referring momentarily to FIG. 3B, exemplary sub-operations of installing a knowledge database are illustrated in accordance with one approach. It follows that one or more of these sub-operations may be used to perform operation 304 of FIG. 3A. However, it should be noted that the sub-operations of FIG. 3B are illustrated in accordance with one approach which is in no way intended to be limiting.

As shown, sub-operation 332 includes dividing a set of base data into a number of text segments. In other words, sub-operation 332 includes dividing RAG source data (e.g., files, documents, etc.) into a plurality of chunks or segments. In different approaches, the base data may be divided into a predetermined number of text segments, into text segments of predetermined size(s), into predetermined types of text segments, etc. In other approaches, the size, number, type, etc. of text segments that are formed from a set of base data may depend on the size and/or type of base data, instructions received from a user, predetermined conditions being met, etc.

From sub-operation 332, the flowchart proceeds to sub-operation 334. There, sub-operation 334 includes converting each of the text segments into segmentation embeddings. In preferred approaches, each embedding corresponds to a respective smaller chunk of the original base data.

In other words, each of the embeddings is produced by converting (e.g., a representation of) objects like text, images, and audio. In some approaches, embeddings are created using deep learning and are vectors of floating-point numbers that represent similarities between objects in a low-dimensional space. Accordingly, each of the embeddings are further combined with respective information to form a vector storage pool. See sub-operation 336. The vector storage pool may include a number of entries that is the same or similar to the number of embeddings formed by converting the base data into a plurality of smaller chunks or “embeddings” as used herein. In some approaches, a vector storage pool is formed for each of the embeddings.

The vector storage pools are preferably combined into a knowledge database that may be referenced to determine specific RAG data to send to edge nodes. For example, one or more AI based models may be trained to evaluate entries in the knowledge database and determine specific portions (e.g., embeddings) of RAG data that should be sent to an edge node. Again, by sending specific portions of RAG data, network strain and processing overhead is reduced, thereby improving performance overall.

Returning now to FIG. 3A, method advances from operation 304 to operation 306. There, operation 306 includes receiving an initial request from node 302. The initial request may specify certain RAG data embeddings to send along a RAG pipeline extending between node 301 and the edge node at node 302. In other approaches, the initial request may not specify RAG data. In some approaches, the initial request is satisfied based on previous (e.g., stored) performance.

In response to receiving the initial request, node 301 collects the relevant RAG data (see operation 308) and sends it to node 302 (see operation 310). It follows that the amount of RAG data sent to node 302 may vary. In response to receiving the RAG data, node 302 evaluates the RAG data and applies at least a portion of it. See operation 312. In other words, node 302 inspects the RAG data received from node 301 and determines whether any of it is relevant (e.g., can be used in the current condition and given the current performance of the edge node). In some approaches, operation 312 includes applying select portions of the RAG data determined as actually being relevant to applications running at the edge node.

From operation 312, method advances to operation 314. There, information outlining the specific RAG data that was actually applied at the edge node as well as the current condition of the edge node are sent back to node 301 in real-time. In other words, the central location at node 301 receives information that describes which RAG data was used at the edge node, along with the conditions that were present at the edge node while the RAG data was applied (e.g., received and actually utilized at the edge node). In addition to information outlining the RAG data that was actually used at the edge node, node 302 may send additional information to node 301 that helps determine how the edge node is operating. For instance, in some approaches the edge node at node 302 collects and sends performance metrics corresponding to how the edge node operated during a given span of time. In other approaches, edge node at node 302 collects information that describes (e.g., outlines) the condition at the edge node while the RAG data was being used.

Proceeding to operation 316, any information received from node 302 is used to dynamically update the knowledge database. In other words, the knowledge database installed in operation 304 is updated over time to include (e.g., incorporate) information outlining how RAG data is used at edge nodes in various conditions and performance characteristics. In some approaches, the received performance metrics, the received edge node condition information, the received information outlining RAG data usage at node 302 (e.g., and other nodes), the knowledge database entries, etc., is used to retrain one or more AI based models that are implemented at the centralized edge orchestrator. This allows for the AI based models to maintain an accurate understanding of the edge nodes and how they utilize RAG data (and other resources) in different conditions.

Accordingly, operation 318 includes causing one or more trained AI based models to dynamically evaluate the performance metrics, the edge node condition information, the received information, the knowledge database, etc., or any other desired information that may have been received from node 302. Moreover, operation 320 includes causing the one or more AI based models to output a relevant subset of RAG data based at least in part on the dynamic evaluation. In other words, operations 318 and 320 include determining what resources (e.g., RAG data) are relevant for at least one edge node based on historical information (e.g., a knowledge database) as well as current conditions and/or settings at the edge node itself, and sending the relevant resources (e.g., RAG data) to the edge node for implementation (e.g., training LLMs for particular applications). This may be achieved in some approaches by sending one or more instructions, commands, requests, files, etc., e.g., as would be appreciated by one skilled in the art after reading the present description. Accordingly, operation 322 includes sending the relevant portions of RAG data back from node 301 to the edge node at node 302. In response to receiving the RAG data, node 302 may utilize the RAG data as desired, e.g., as would be appreciated by one skilled in the art after reading the present description.

It should be noted that although FIG. 3A shows a central node 301 dynamically controlling the flow of RAG data to one edge node 302 based at least in part on real-time performance at node 302, this is in no way intended to be limiting. Rather, central node 301 may monitor and control the flow of RAG data to any desired number of edge nodes individually and in parallel. Moreover, RAG data may flow from the central node 301 to each of the edge nodes along respective pipelines. It follows that approaches herein are desirably able to implement LLMs and other data and/or training intensive models with minimal impact on the system overall.

Approaches herein are thereby desirably able to continue advancing generative AI and promote new opportunities, particularly in the telecommunications industry. Moreover, networking clients would benefit from approaches herein by being able to augment operations with generative AI use cases, e.g., as would be appreciated by one skilled in the art after reading the present description. Approaches can thereby achieve faster operations to further support services being performed at edge locations.

Approaches herein focus on filtering the RAG retrieval to obtain the data that is the most relevant for given situations (e.g., prompts). As noted above, this is achieved herein by implementing dynamic adaptation of the RAG content that is deployed at the edge, particularly as the edge conditions change over time. Approaches herein are thereby desirably able to achieve the minimum RAG deployment on the limited edge resources at each observed moment in time.

While current (e.g., real-time) factors may be taken into consideration while determining the relevant resources (e.g., RAG data) to send to an edge node in real-time, other considerations may be made. For example, predictions of future edge node conditions may be made. Referring momentarily now to FIG. 3C, an exemplary flowchart 350 for predicting future edge node conditions and/or performance metrics are illustrated in accordance with one approach. It follows that one or more of these sub-operations may be used to supplement the operations of FIG. 3A, e.g., such as operation 320. However, it should be noted that the sub-operations of FIG. 3C are illustrated in accordance with one approach which is in no way intended to be limiting.

As shown, operation 352 includes causing one or more generative AI models to evaluate historical performance data and predict future edge node conditions. The generative AI models are preferably trained to make predictions at the edge nodes, based at least in part on historical data (e.g., stored in the knowledge database). Depending on the approach, operation 352 may be achieved in some approaches by sending one or more instructions, commands, requests, files, etc., e.g., as would be appreciated by one skilled in the art after reading the present description. In some approaches, the generative AI based models may be trained to predict future edge node performance metrics.

Moreover, operation 354 includes causing the one or more trained AI based models to dynamically evaluate the future edge node conditions and the knowledge database. In other words, the AI based models that have been trained to evaluate conditions (e.g., present or future) and/or performance metrics (e.g., present or future) in order to determine the relevant portions of available RAG data to send to the edge node. Thus, the trained AI based models output a subset of the available RAG data. See operation 356. In some approaches, the subset of relevant RAG data may be output along with an anticipated relevancy. In other words, the trained AI based models determine what information is anticipated to be relevant for the edge node based on predictions output by the generative AI based models and/or trained AI based models.

Accordingly, the subset of available RAG data predicted as being relevant to the future conditions and/or performance metrics is actually output by the trained AI based models. Moreover, operation 358 includes replacing at least a portion of the RAG data currently being sent to the edge node (e.g., along the RAG pipeline) with at least a portion of the RAG data anticipated as being relevant. However, in some approaches operation 358 may include adding to (e.g., supplementing) the RAG data currently being sent to the edge node. In other approaches, operation 358 may include removing portions of the RAG data currently being sent to the edge node. It follows that the RAG data corresponding to the predicted edge node conditions and/or performance metrics may be merged with the RAG data currently being sent to the edge node in a number of different ways, e.g., depending on the desired approach. In further approaches, operation 358 is performed in response to waiting until a predetermined time. For instance, operation 358 may be implemented in response to reaching a date, time of day, predetermined condition, etc., that corresponds to the predicted edge node condition(s) and/or performance metrics.

With continued reference to FIG. 3C, the flowchart 350 advances from operation 358 to operation 360. There, operation 360 includes sending (e.g., transferring) the merged RAG data (e.g., resources) from the centralized edge orchestrator to the respective edge node. Again, this allows for only resources predicted as being relevant to be sent to edge nodes. This allows for network traffic to be reduced, while also decreasing the computer overhead and latency experienced at each edge node.

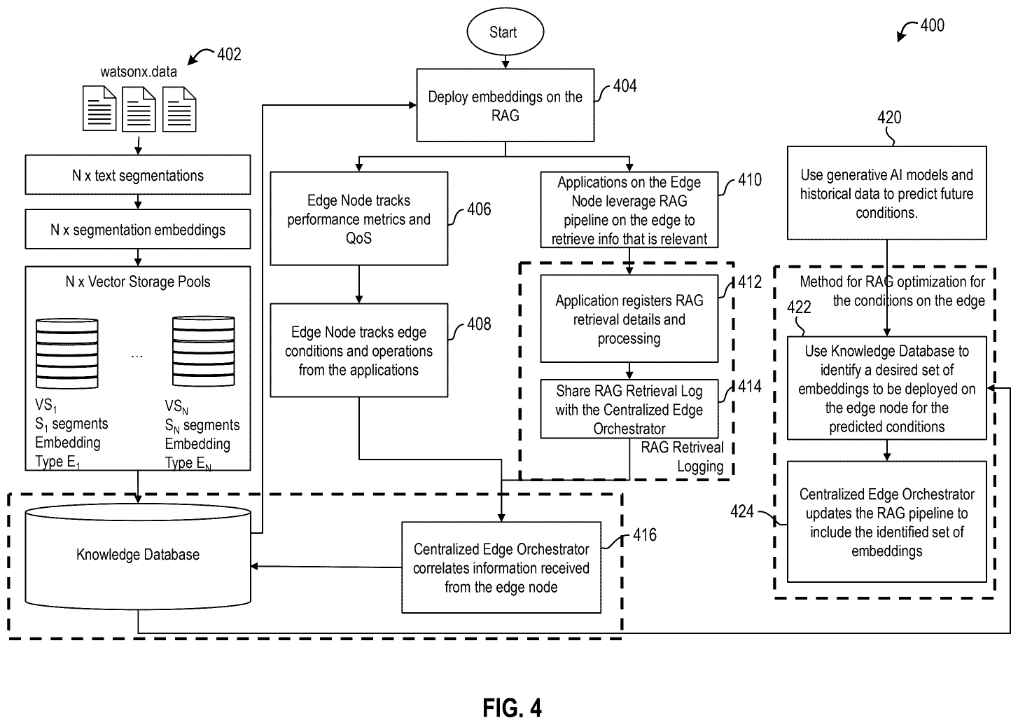

Looking now to FIG. 4, a distributed system 400 is depicted in accordance with an in-use example, which is in no way intended to be limiting. The present system 400 may be implemented in conjunction with features from other approaches listed herein, such as those described with reference to the other FIGS. Further, the system 400 presented herein may be used in any desired environment. Thus FIG. 4 (and the other FIGS.) may be deemed to include any possible permutation.

As shown, in some approaches the base data 402 is watsonx.data. The base data 402 is received and divided into “N” text segmentations. The N text segmentations are further converted into N segmentation embeddings. The N segmentation embeddings are used to form (e.g., create) N Vector Storage Pools. Each of the Vector Storage Pools include a unique vector storage identifier (e.g., VS1), one or more segments (e.g., S1 segments) of the original base data 402, at least one embedding (e.g., Embedding) that corresponds to the one or more segments, and the type of edge environment (e.g., Type E1) the base data was utilized in. These vector storage pools thereby provide an efficient and segmented process of locating relevant sections of the base data 402 given on the specific situations the edge node is faced with.

The N Vector Storage Pools are further used to form a Knowledge Database. In preferred approaches, the Knowledge Database is formed by identifying mappings between edge conditions and/or edge performance, and vector storage and/or segment relevance, e.g., as described herein. Moreover, one or more AI based models may be trained on the information included in the Knowledge Database, and may thereby be configured identify a relevant portion of the information included in the Knowledge Database. This relevant portion of the information may thereby be sent to an edge node for implementation. According to an example, the Knowledge Database stores RAG data and is configured to generate a relevant portion of available RAG data to send to an edge node based at least in part on performance experienced at the edge node, the current status of the edge node, anticipated workloads at the edge node (e.g., output by one or more generative AI models trained to predict future edge node conditions, etc.).

Accordingly, in response to an edge node being initialized “Start”, the Knowledge Database is referenced to deploy embeddings to the edge node. For instance, operation 404 includes deploying embeddings on the RAG pipeline that extends between the centralized edge orchestrator and the edge node. In some approaches, the initial embeddings that are deployed on the edge node may be randomly selected, based at least in part on a last operation performed at the edge node, based at least in part on current conditions at the edge node (e.g., determined during initialization of the edge node), etc.

Looking to operation 406, the edge node tracks operating metrics, a quality of service (QOS) experienced by users at the edge node, and any other performance related details. This may be achieved by collecting sensor readings, storing outputs produced by trained AI based models, recording performance of the edge node itself, etc. Moreover, this tracked information is preferably returned to the centralized edge orchestrator. In some approaches, the tracked performance information may be sent to the centralized edge orchestrator periodically (e.g., at fixed or random intervals), in response to a predetermined amount of the performance information being collected, in response to receiving a request from the centralized edge orchestrator, in response to predicting upcoming workloads and/or edge conditions, etc.

Proceeding to operation 408, the edge node also tracks edge conditions as well as the operations that are performed at the edge node itself. In other words, operation 408 includes storing information that outlines the conditions (e.g., operating state, error status indicators, workload level warnings, data overflowing memory thresholds, etc. Thus, while operation 406 may track the specific performance metrics that are achieved at the edge node, operation 408 may track what the edge node itself is experiencing while achieving the performance metrics. The tracked edge conditions are also preferably returned to the centralized edge orchestrator. In some approaches, the tracked edge conditions may be sent to the centralized edge orchestrator periodically (e.g., at fixed or random intervals), in response to a predetermined amount of the performance information being collected, in response to receiving a request from the centralized edge orchestrator, in response to predicting upcoming workloads and/or edge conditions, etc.

Returning to operation 404, the flowchart also advances to operations 410, 412, and 414 in parallel with operations 406 and 408. It follows that various operations may be performed simultaneously and/or in parallel, e.g., depending on the desired application. As shown, operation 410 includes receiving relevant information from the centralized edge orchestrator along the RAG pipeline that extends therebetween. In other words, RAG data is sent from the centralized edge orchestrator to the edge node along the RAG pipeline, e.g., as described herein.

From operation 410, the flowchart proceeds to the RAG Retrieval Logging procedure, which includes operations 412 and 414 as shown. Operation 412 involves applications running at the edge node to register the received RAG retrieval information (e.g., details). In some approaches, the RAG retrieval information may be registered by processing the information in a RAG retrieval log, e.g., as would be appreciated by one skilled in the art after reading the present description.

Moreover, operation 414 includes the Edge Node sharing the RAG retrieval log with the centralized edge orchestrator. In other words, the Edge Node informs the centralized edge orchestrator of which received RAG data was actually applied (e.g., utilized) at the edge node. In other words, while specific RAG data may be sent to an edge node, the edge node may not use portions of the received RAG data. By tracking the RAG data that is used at the edge node, the centralized edge orchestrator may use this tracked information to train AI based models to recognize patterns and relationships between the various information. At least some of these AI based models may thereby be trained and configured to evaluate information associated with an edge node, learn how to identify resources that are relevant to the evaluated information, and/or predict future edge node conditions and/or performance metrics, e.g., as described in the approaches herein. For example, AI models may be trained to evaluate performance metrics, edge node condition information, information outlining specific resources (e.g., RAG data) applied at edge nodes, knowledge databases, etc., and output resources that are relevant to the evaluated information. In another example, AI models may be trained to identify RAG data that is relevant to the evaluate performance metrics, edge node condition information, etc., and output it. In still another example, AI models may be trained to evaluate the future edge node conditions and the knowledge database and output a subset of RAG data with anticipated relevancy.

From operation 414, the flowchart proceeds to operation 416. Operation 416 is performed at the centralized edge orchestrator, and includes correlating information received from the edge node. In other words, operation 416 includes correlating performance reports, edge condition reports, local RAG Retrieval Log information received from the edge node, etc., in an effort to identify the actual RAG data that was utilized at the edge node. This allows the centralized edge orchestrator to identify RAG data that was sent to the edge node, but not actually used. This identified unused RAG data may thereby be used to retrain the AI based models, update the Knowledge Database (e.g., see arrowed line extending from operation 416 to Knowledge Database), etc. Operation 416 is thereby able to assess RAG retrieval quality at edge nodes, as well as management of the Knowledge Database.

Looking now to operation 420, the centralized edge orchestrator uses generative AI models to evaluate historical data associated with the conditions of the edge nodes (e.g., information stored in the Knowledge Database) and make predictions of future edge node conditions. In other words, operation 420 involves generative AI models producing projections of how the edge node (or other edge nodes) will operate and/or what the edge node will experience. As shown, an output of the generative AI models is passed to operation 422. There, operation 422 includes the centralized edge orchestrator reading the Knowledge Database to identify a desired set of embeddings (e.g., portions of the RAG data) to be deployed on the edge node for the predicted future set of conditions. In other words, the mappings in the Knowledge Database are evaluated to identify sections of data that are predicted to be relevant to the conditions the edge node is projected to experience. Furthermore, operation 424 includes the centralized edge orchestrator updating the RAG pipeline extending between the centralized edge orchestrator and the edge node, to incorporate the RAG data identified in operation 422. In some approaches, the identified RAG data is used to replace at least a portion of the RAG data currently being received at the edge node. In other approaches, the identified RAG data supplements the RAG data already being sent to the edge node. In still other approaches, portions of the RAG data being sent to the edge node may simply be stopped, e.g., in response to the identified RAG data not including portions of the RAG data currently being sent. Accordingly, operation 424 is shown as returning to operation 404, as well as updating the Knowledge Database (e.g., see arrowed lines).

In some approaches, one or more of the operations in method 300, flowchart 350, and/or the operations performed in the system 400 of FIG. 4, may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to evaluate information associated with an edge node. For example, AI models may be trained to evaluate performance metrics, edge node condition information, information outlining specific resources (e.g., RAG data) applied at edge nodes, knowledge databases, etc., and output resources that are relevant to the evaluated information. Training of the AI model, in some approaches, may be performed by applying a predetermined training data set to learn how to identify resources that are relevant to the evaluated information. For example, AI models may be trained to identify RAG data that is relevant to the evaluate performance metrics, edge node condition information, etc., and output it. Training of the AI model, in still some other approaches, may be performed by applying a predetermined training data set to learn how to predict future edge node conditions and/or performance metrics. For example, AI models may be trained to evaluate the future edge node conditions and the knowledge database and output a subset of RAG data with anticipated relevancy. Initial training may include reward feedback that may, in some approaches, be implemented using a subject matter expert (SME) that generally understands relevancy of RAG data in training LLMs. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300, flowchart 350, and/or the operations performed in the system 400 of FIG. 4 may be performed. In some further approaches, the AI model may be a neuromyotonic AI model that may improve performance of computer devices in an infrastructure associated with using RAG data to train LLMs to function as desired, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from edge nodes and/or the LLMs that may be implemented thereat. Such an AI model ensures that relevant resources (e.g., RAG data) are sent to edge nodes irrespective of the conditions and/or performance experienced, where the scale of such analysis and determinations would not otherwise be feasible for a human to perform. This is because humans are not able to efficiently evaluate the countless factors at play, and would otherwise incorporate processing delays and errors in identifying resources that are relevant to a given condition and/or performance metrics in the process of attempting to do so. Accordingly, management of operations described herein is not able to be achieved by human manual actions.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
receiving, from an edge node, information outlining specific retrieval-augmented generation (RAG) data applied at the edge node and a condition of the edge node in real-time;
updating a knowledge database with the received information, the knowledge database mapping embeddings of RAG data to various edge node conditions;
causing one or more trained artificial intelligence (AI) based models to:
dynamically evaluate the received information and the knowledge database, and
output a relevant subset of RAG data; and
sending the relevant subset of RAG data to the edge node.

2. The CIM of claim 1, further comprising:
receiving, from the edge node, performance metrics corresponding to the edge node;
receiving, from the edge node, edge node condition information corresponding to the edge node; and
causing the one or more trained AI based models to:
dynamically evaluate the performance metrics, the edge node condition information, the received information, and the knowledge database, and
output the relevant subset of RAG data.

3. The CIM of claim 2, wherein the knowledge database is formed by:
dividing base data into a number of segments;
converting the segments into the embeddings; and
combining the embeddings with respective information to form vector storage pools.

4. The CIM of claim 3, wherein one of the vector storage pools is formed for the respective embeddings.

5. The CIM of claim 1, wherein the operations are performed by a centralized edge orchestrator.

6. The CIM of claim 5, wherein the relevant subset of RAG data is sent to the edge node along a RAG pipeline extending between the edge node and the centralized edge orchestrator.

7. The CIM of claim 1, further comprising:
causing one or more generative AI models to predict future edge node conditions; and
causing the one or more trained AI based models to:
dynamically evaluate the future edge node conditions and the knowledge database, and
output a subset of RAG data with anticipated relevancy.

8. The CIM of claim 7, further comprising:
replacing at least a portion of the relevant subset of RAG data with at least a portion of the subset of RAG data; and
sending a remainder of the relevant subset of RAG data and the subset of RAG data to the edge node.

9. A computer program product (CPP), comprising:
a set of one or more computer-readable storage media; and
program instructions, collectively stored in the set of one or more storage media, for causing a processor set to perform the following computer operations:
receive, from an edge node, information outlining specific retrieval-augmented generation (RAG) data applied at the edge node and a condition of the edge node in real-time;
update a knowledge database with the received information, the knowledge database mapping embeddings of RAG data to various edge node conditions;
cause one or more trained artificial intelligence (AI) based models to:
dynamically evaluate the received information and the knowledge database, and
output a relevant subset of RAG data; and
send the relevant subset of RAG data to the edge node.

10. The CPP of claim 9, wherein the program instructions are for causing the processor set to further perform the following computer operations:
receive, from the edge node, performance metrics corresponding to the edge node;
receive, from the edge node, edge node condition information corresponding to the edge node; and
cause the one or more trained AI based models to:
dynamically evaluate the performance metrics, the edge node condition information, the received information, and the knowledge database, and
output the relevant subset of RAG data.

11. The CPP of claim 10, wherein the knowledge database is formed by:
dividing base data into a number of segments;
converting the segments into the embeddings; and
combining the embeddings with respective information to form vector storage pools.

12. The CPP of claim 11, wherein one of the vector storage pools is formed for the respective embeddings.

13. The CPP of claim 9, wherein the operations are performed by a centralized edge orchestrator.

14. The CPP of claim 13, wherein the relevant subset of RAG data is sent to the edge node along a RAG pipeline extending between the edge node and the centralized edge orchestrator.

15. The CPP of claim 9, wherein the program instructions are for causing the processor set to further perform the following computer operations:
cause one or more generative AI models to predict future edge node conditions; and
cause the one or more trained AI based models to:
dynamically evaluate the future edge node conditions and the knowledge database, and
output a subset of RAG data with anticipated relevancy.

16. The CPP of claim 15, wherein the program instructions are for causing the processor set to further perform the following computer operations:
replace at least a portion of the relevant subset of RAG data with at least a portion of the subset of RAG data; and
send a remainder of the relevant subset of RAG data and the subset of RAG data to the edge node.

17. A computer system (CS), comprising:
a processor set;
a set of one or more computer-readable storage media; and
program instructions, collectively stored in the set of one or more storage media, for causing the processor set to perform the following computer operations:
receive, from an edge node, information outlining specific retrieval-augmented generation (RAG) data applied at the edge node and a condition of the edge node in real-time;
update a knowledge database with the received information, the knowledge database mapping embeddings of RAG data to various edge node conditions;
cause one or more trained artificial intelligence (AI) based models to:
dynamically evaluate the received information and the knowledge database, and
output a relevant subset of RAG data; and
send the relevant subset of RAG data to the edge node.

18. The CS of claim 17, wherein the program instructions are for causing the processor set to further perform the following computer operations:
receive, from the edge node, performance metrics corresponding to the edge node;
receive, from the edge node, edge node condition information corresponding to the edge node; and
cause the one or more trained AI based models to:
dynamically evaluate the performance metrics, the edge node condition information, the received information, and the knowledge database, and
output the relevant subset of RAG data.

19. The CS of claim 18, wherein the knowledge database is formed by:
dividing base data into a number of segments;
converting the segments into the embeddings; and
combining the embeddings with respective information to form vector storage pools.

20. The CS of claim 17, wherein the program instructions are for causing the processor set to further perform the following computer operations:
cause one or more generative AI models to predict future edge node conditions; and
cause the one or more trained AI based models to:
dynamically evaluate the future edge node conditions and the knowledge database, and
output a subset of RAG data with anticipated relevancy.
